(19) United States
(12) Patent Application Publication
(10) Pub. No.: US 2014/0276282 A1
(43) Pub. Date: Sep. 18, 2014

(54) AIR MASSAGE DEVICE FOR A BED

(71) Applicants: RUOEY LUNG ENTERPRISE CORP., Lu-Kang Town (TW); PPJ. LLC, Natick, MA (US)

(72) Inventors: Philip Woods McCARTY, Natick, MA (US); Philip Reid SHERMAN, Melville, NY (US); Chuan-Hang SHIH, Lu-Kang Town (TW)

(73) Assignees: PPJ. LLC, Natick, MA (US); RUOEY LUNG ENTERPRISE CORP., Lu-Kang Town (TW)

(21) Appl. No.: 13/831,135

(22) Filed: Mar. 14, 2013

(51) Int. Cl. A61H 9/00

(52) U.S. Cl. CPC A61H 9/0007
USPC 601/150

(57) ABSTRACT

The present invention provides an air massage device for a bed. The air massage device includes at least one air wave generator disposed on the bed. The air wave generator includes a shell, a permanent magnet disposed in the shell, a coil electromagnet movably disposed in the shell and a membrane attached to the coil electromagnet. When the coil electromagnet is powered by an alternating current, the coil electromagnet moves reciprocatingly relative to the permanent magnet along with the membrane so that the membrane generates an air wave which is adapted to massage people on the bed.

### BACKGROUND OF THE INVENTION

1. Field of the Invention

The present invention relates to a massage device for a bed, and more particularly to an air massage device for a bed.

2. Description of the Related Art

There are some beds that can massage the user's body to ease away fatigue of the body and soul. These beds are provided with vibrating motors, motor-driven massage members and/or air bags that can contact with the body in order to perform massage actions. However, such massaging parts are not easy to install on the bed.

### SUMMARY OF THE INVENTION

Therefore, it is the primary objective of the present invention to provide an air massage device for the bed that uses air waves to massage the body.

To achieve this and other objectives of the present invention, the air massage device includes at least one air wave generator disposed on the bed. The air wave generator includes a shell, a permanent magnet disposed in the shell, a coil electromagnet movably disposed in the shell and a membrane disposed on the coil electromagnet. When the coil electromagnet is powered, the coil electromagnet moves reciprocally relative to the permanent magnet along with the membrane so that the membrane generates an air wave which is adapted to massage people on the bed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a sectional view of an air massage device according to a preferred embodiment of the present invention;

FIG. 2 is a side view of a bed having a air massage device according to a preferred embodiment of the present invention.

### DETAILED DESCRIPTION OF THE INVENTION

Please refer to FIGS. 1 and 2. In a preferred embodiment of the present invention, an air massage device for a bed 2 includes multiple air wave generator 1 disposed on the bed 2. It is noted that the air massage device can still work even if there is only one air wave generator 1.

The air wave generator 1 includes a shell 10, a permanent magnet 20 disposed in the shell 10, a coil electromagnet 30 movably disposed in the shell 10 and a membrane 40 attached to the coil electromagnet 30, The shell 10 defines a chamber 11 to receive the permanent magnet 20, the coil electromagnet 30 and the membrane 40 therein. The permanent magnet 20 is preferably annular in shape that surrounds the coil electromagnet 30, or the permanent magnet 20 can be disposed on opposite outer sides of the coil electromagnet 30. The membrane 40 is preferably in cone shape and has a smaller diameter end 41 attached to the coil electromagnet 30 and a bigger diameter end 42 remote from the coil electromagnet 30.

When the coil electromagnet 30 is powered by an alternating current, the coil electromagnet 30 moves reciprocatingly relative to the permanent magnet 20 along with the membrane 40 so that the membrane 40 generates an air wave which is adapted to massage people on the bed 2.

Since the air wave generator 1 utilizes air wave to simulate massage action and does not need to mechanically contact the body of the people on the bed 2, the air wave generator 1 can be preferably disposed on the bottom of the bed frame 3. It is noted that if the air wave generator 1 generates the air wave in the human audible frequencies, the air wave can sometimes be noisy to the users. Therefore, it is preferable that the air wave generated is unaudible to humans. For example, the air wave can have a frequency lower than 20 Hertz, preferably between 0.001-20 Hertz, and is not in human's hearing range.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An air massage device for a bed, comprising at least one air wave generator disposed on the bed, the air wave generator comprising a shell, a permanent magnet disposed in the shell, a coil electromagnet movably disposed in the shell and a membrane attached to the coil electromagnet;
wherein when the coil electromagnet is powered by an alternating current, the coil electromagnet moves reciprocatingly relative to the permanent magnet along with the membrane so that the membrane generates an air wave which is adapted to massage people on the bed.

2. The air massage device of claim 1, wherein the air wave generated by the air wave generator is unaudible to humans.

3. The air massage device of claim 1, wherein the air wave generator is disposed on a bed frame of the bed.
